(19) United States
(12) Patent Application Publication
(10) Pub. No.: US 2014/0299254 A1
(43) Pub. Date: Oct. 9, 2014

(54) Laminated Foam Insulating Label

(71) Applicant: Avery Dennison Corporation, Glendale, CA (US)

(72) Inventors: Mitchell J. RACKOVAN, Madison, OH (US); Mark DANNER, Chardon, OH (US); James HING, Warren, MI (US)

(73) Assignee: Avery Dennison Corporation, Glendale, CA (US)

(21) Appl. No.: 14/211,334

(22) Filed: Mar. 14, 2014

Related U.S. Application Data
(60) Provisional application No. 61/791,128, filed on Mar. 15, 2013.

(51) Int. Cl. B65C 3/14; G09F 3/00

(52) U.S. Cl. CPC B65C 3/14; G09F 3/0291
USPC 156/85; 428/314.4; 428/314.8; 428/212; 428/220; 428/317.1

(57) ABSTRACT

A label system including a heat shrinkable foam layer and a heat shrinkable overlaminate layer is described. The label can be applied to a container prior to and/or during heat shrinking. The shrinkage characteristics of the foam layer and the overlaminate layer are matched to one another. Also described are various methods of labeling and/or packaging using the noted label systems.

### CROSS REFERENCE TO RELATED APPLICATION

The present application claims the benefit of U.S. Provisional Application No. 61/791,128 filed Mar. 15, 2013, which is incorporated herein by reference in its entirety.

### FIELD

The present subject matter relates to heat shrinkable labeling systems that include a heat shrinkable foam insulating layer and a heat shrinkable label or print receiving layer. The subject matter also relates to methods of using the labeling systems.

### BACKGROUND

In the packaging of liquids, metal and plastic cans are employed which typically include external printing. The printing identifies the source of the packaged substances and includes other information such as weight and details as to the contents. This printing has previously been directly applied to the cans, which greatly limits the flexibility of a user's inventory. For example, if a packager or canner of soda orders a large number of preprinted cans and desires to switch to a different liquid beverage to be placed therein, the preprinted cans become useless.

In any event, it is recognized that it would be a matter of great convenience, for canners to be able to stock unprinted cans or containers and to be able to selectively apply labels thereto depending upon the contents.

Many labels are available for the labeling of metal and plastic containers. Paper labels have been known for years. Polymeric film labels are widely used. Direct printing on polymeric films has provided industry standards. Direct printing is glossy, the colors and data exhibited are aesthetically attractive and more easily perceived, and the printing is generally more scuff resistant.

However, labeling difficulties may arise from specific shapes of certain cans or containers. That is, certain cans or containers taper inwardly at their upper and lower extremities and a label must either avoid extending to these extremities or must conform closely to the shapes thereof.

Thermal insulating labels for beverage containers such as cans and bottles are also known in the art. However, such labels are often difficult to apply particularly to complex geometries or tapering container sidewalls, without undesirable darts or wrinkles occurring. Furthermore, currently known insulating labels suffer from one or more of the following traits: their thickness may impede label application and/or conformability to a container, they may present an undesirable appearance, and/or they may be costly to produce and/or apply.

Accordingly, a need exists for an insulated label material which is inexpensive to manufacture. The insulated label material should be thick enough to provide adequate insulation, but thin enough to be flexible and be used as a label on cans or containers with varying geometries. It also would be advantageous for such a material to exhibit heat-shrink properties so that the material could be fit over containers with simple and/or complex contours without losing insulation properties and without producing darts or wrinkles. And, the insulated label material should exhibit the properties associated with direct printed film labels.

### SUMMARY

The difficulties and drawbacks associated with previously known labeling materials are addressed in the present laminated foam insulating label and related methods.

In one aspect, the present subject matter provides a multilayer heat shrinkable label assembly comprising an overlaminate layer and a foam layer adhered to the overlaminate layer. The foam layer includes a material selected from the group consisting of polystyrene, polyethylene, polyurethane, polyvinyl chloride, polyolefin(s), and combinations thereof. In certain embodiments, the foam layer includes at least 50% closed cells.

In another aspect, the present subject matter provides a multilayer heat shrinkable label assembly comprising a foam layer and an overlaminate layer. The overlaminate layer includes material selected from the group consisting of polystyrene, polyethylene terephthalate (PET), biaxially oriented polypropylene (BOPP), polyvinyl chloride, polyethylene terephthalate glycol-modified (PETG), polyolefins, polyolefin blends, and combinations thereof. The multilayer label assembly also comprises an adhesive layer disposed between the foam layer and the overlaminate layer.

In yet another aspect, the present subject matter provides a method of labeling a container. The method comprises providing a multilayer heat shrinkable label assembly including (i) an overlaminate layer, and (ii) a foam layer, the foam layer defining an inner face. The method also comprises contacting the inner face of the multilayer heat shrinkable label assembly to a container. And, the method additionally comprises heating the multilayer heat shrinkable label assembly about at least a portion of the container, whereby both the overlaminate layer and the foam layer undergo shrinkage, to thereby label the container.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is an exploded schematic view of a laminated foam insulating label in accordance with the present subject matter.

FIG. 2 is a schematic cross sectional view of the label of FIG. 1.

FIG. 3 is a representative view of a beverage container having a label adhered to its outer periphery, in accordance with the present subject matter.

### DETAILED DESCRIPTION OF THE EMBODIMENTS

The present subject matter provides a multilayer heat shrinkable label assembly which includes a thermally insulating, heat shrinkable foam layer. The label assembly also includes a heat shrinkable overlaminate layer which provides an inwardly directed print-receiving face. In certain versions of the label assembly, the overlaminate layer is formed from an optically clear or transparent material. The overlaminate layer is adhered to the foam layer by an adhesive layer or region disposed between the overlaminate layer and the foam layer. In certain versions of the present subject matter, the shrink characteristics of the overlaminate layer correspond or substantially so, to the shrink characteristics of the foam layer. These and other details including descriptions of materials and aspects of each component in the multilayer label assembly are as follows.

### Foam Layer

The thermal insulating layer is in the form of a polymeric foam layer. This layer comprises a foamed polystyrene, foamed polyethylene, foamed polyurethane, foamed polyvinyl chloride, foamed polyolefin, and/or combinations thereof. In certain embodiments, the foam is a polystyrene foam.

The foam layer is heat shrinkable. Such heat shrinkable foam layers are typically produced by extruding a foamed layer followed by quick quenching and by orientation of the foam layer by stretching the foam layer under temperature conditions at which molecular orientation occurs and the foam layer does not tear. Upon subsequent reheating to a temperature at or close to the orientation temperature, the foam layer will tend to shrink, seeking to recover its original dimensional state. The foam layer(s) used in the present subject matter label assemblies can be formed to shrink in one direction, e.g., unidirectional or mono-directional; or in two directions, e.g., bidirectional.

The foam may be either a dosed cell foam, an open cell foam, or include both dosed cells and open cells. In particular versions of the present subject matter, the foams include at least 50% dosed cells, more particularly at least 75% dosed cells, and in still other versions at least 90% dosed cells.

The present subject matter includes foams having a wide array of densities. In certain embodiments, the foam has a density in a range of from 0.15 g/cm³ to 0.50 g/cm³, and more particularly from 0.25 g/cm³ to 0.35 g/cm³.

The thickness of the foam layer may vary depending upon the particular application. For certain uses, a typical thickness is from 0.8 mils to 20 mils, and more particularly from 1 mil to 14 mils.

### Overlaminate Layer

A wide array of layers, wrapping, films, and/or laminates can be used for the overlaminate layer in the multilayer heat shrinkable label systems of the present subject matter. The heat shrinkable overlaminate layer typically includes a biaxially oriented, heat shrinkable film. Biaxially oriented heat shrinkable films are typically produced by extruding or co-extruding polymers from a melt into a thick film, followed by a quick quenching and by orientation of the thick film by stretching the film under temperature conditions where molecular orientation of the film occurs and the film does not tear. Upon subsequent re-heating at a temperature close to the orientation temperature the film will tend to shrink, seeking to recover its original dimensional state. The overlaminate layer(s) used in the present subject matter label assemblies can be formed to shrink in one direction or in two directions.

In certain versions of the present subject matter, the heat shrinkable overlaminate layer will shrink from about 1% to about 40%, more preferably from about 20% to about 40%, more preferably from about 25% to about 35%, and more preferably from about 30% to about 35%, in the machine or longitudinal direction, and from about 1% to about 50%, more preferably from about 20% to about 50%, more preferably from about 30% to about 45%, and more preferably from 38% to 45%, in the transversal (or transverse) direction when heated to a sufficient heat shrink temperature, such as for example about 85° C. However, it will be appreciated that in no way is the subject matter limited to these particular shrinkage extents. These shrinkage extents are periodically referred to herein as the shrinkage characteristics associated with the preferred embodiment overlaminate layer.

In addition and as previously noted, it will be understood that the present subject matter includes the use of overlaminate films which only shrink in one of the machine direction or the transverse direction. The present subject matter also includes the use of overlaminate films that shrink in both the machine direction and the transverse direction.

Details as to particular techniques for effecting shrinkage are described in greater detail herein.

The overlaminate layer typically includes one or more polymeric materials such as polystyrene, polyethylene terephthalate (PET), biaxially oriented polypropylene (BOPP), polyvinyl chloride, polyethylene terephthalate glycol-modified (PETG), polyolefins, polyolefin blends, and combinations thereof.

The present subject matter includes the use of a wide range of thicknesses for the overlaminate layer. Typical thicknesses may range from 0.40 mils to 5 mils, and particularly from 0.48 mils to 4 mils.

In certain versions of the present subject matter, the overlaminate layer exhibits particular optical properties. In certain embodiments, an overlaminate layer as described herein exhibits a clarity of greater than 90% and more particularly greater than 95%. These clarity values are determined using an industry standard clarity meter. Clarity is measured in accordance with ASTM D1003. The overlaminate layer in certain embodiments also exhibits certain haze values. For example, the overlaminate layer may exhibit a haze of less than 10%, and more particularly less than 5%. Haze is measured using an industry standard haze meter. Haze is measured in accordance with ASTM D1003. The overlaminate layer in certain versions may also exhibit particular levels of gloss. For example in certain versions, the overlaminate layer exhibits a 60 degree gloss measurement of greater than 100, and more particularly greater than 120. Sixty degree gloss is measured in accordance with ASTM D2457, and by use of an industry standard gloss meter.

In certain versions of the present subject matter, using a clear or transparent overlaminate layer, the overlaminate is reverse printed. Reverse printing involves applying text, designs, and/or other indicia on an inner face of the overlaminate. Upon application of the label assembly to a can or other container of interest, the applied indicia is visible through the thickness of the overlaminate layer. It will be understood that the present subject matter includes printing text, designs, or other indicia on an outer face of the overlaminate layer.

In certain versions of the present subject matter, one or more faces of the overlaminate layer may be treated and/or receive treatments and/or coatings. For example, one or both faces of the overlaminate layer may be corona treated, and/or plasma treated as known in the art. It is also contemplated that one or both faces of the overlaminate layer could also be top coated and/or receive one or more coextruded layers such as a skin layer. These treatments and/or coatings can impart improved ink anchorage properties and/or ink “wet out” as measured according to ASTM D3359.

The heat shrinkable label assembly typically exhibits a multilayer structure comprising an overlaminate layer and a foam layer. Other layers may be present in the label assembly in order to provide the resulting label assembly with the thickness and the mechanical properties required. The polyvinyl chloride (PVC), polystyrene, polyester, and polyolefin families of shrink films provide a wide range of physical and performance film characteristics. Film characteristics play an important role in the selection of a particular film and may differ for each type of labeling application. Polyolefins have been most successful with applications in which moderate to high shrink forces are preferred. Polyolefin films are also used on automatic, high speed shrink wrapping equipment where shrink and sealing temperature ranges are more clearly controlled.

### Adhesive Layer(s)

A wide array of adhesives can be used. One or more adhesives can be used to at least initially attach the label assembly to a can or container of interest. One or more adhesives can also be used within and/or between layers in the label assembly. Although not necessary, it is preferred that an effective amount of adhesive be carried with the label and disposed along an underside or along an inner face of the label assembly as described in greater detail herein. In many applications, it is preferred that the adhesive and more particularly, an acrylic emulsion adhesive exhibiting relatively high water resistance properties be utilized. However, it will be appreciated that in no way is the subject matter limited to such adhesives. Instead, it is contemplated that the present subject matter label assemblies can utilize other adhesives and adhesive systems, or be free of adhesive along their container-facing surface.

The label assemblies of the present subject matter include one or more layers or regions of adhesive, e.g., a lamination adhesive, disposed between the overlaminate layer and the foam layer. A wide range of coatweights can be used, such as from about 0.2 g/m² to about 15 g/m² or more, and particularly from 0.5 g/m² to 10 g/m². However, it will be understood that the present subject matter includes the use of adhesive coatweights greater than or less than these amounts. It will also be understood that the adhesive layer may be continuous, noncontinuous, or pattern coated. Various adhesives can be used as a lamination adhesive. For example, lamination adhesives are commercially available from Henkel Adhesives, Flint, and others. For many applications, water based and UV and/or EB (election beam) curable adhesives can be used.

### Label Assembly

The films used in the laminated foam insulating label assemblies typically include multiple layers, the different layers providing the labels with the physical and the mechanical properties required. In general, the multilayer heat shrinkable label assemblies have a total thickness of from about 1.5 mils to about 20 mils, and particularly from 2 mils to 15 mils.

Preferably, the shrink characteristics of the heat shrinkable overlaminate layer and the heat shrinkable foam layer are tailored to one another or “matched” such that upon being subjected to a shrinking operation, the overlaminate layer and foam layer exhibit similar degrees and/or rates of shrinkage. The term “matched” as used herein refers to selecting, producing, or otherwise designing the heat shrinkable foam layer to exhibit equivalent shrink characteristics as the heat shrinkable overlaminate layer, or vice-versa, such that when the components are simultaneously subjected to a shrinking operation, no undue stresses or material deformations are induced which result in disruption along the interface between the components. Thus, no darts, wrinkles, peel-up, or distortion are exhibited in the label. For versions of the label assembly that include additional layers, the term “matched” also refers to selecting, producing, or otherwise designing the heat shrinkable foam layer and/or the heat shrinkable overlaminate layer to exhibit equivalent shrink characteristics to the additional layers, or vice-versa. More specifically, the term “matched” refers to one of the components of the multilayer label assembly, e.g., the foam layer or the overlaminate layer, to exhibit a shrinkage extent that is within a particular percentage range of shrinkage of the other component. In certain versions of the present subject matter, the differential for machine direction (MD) shrinkage of the foam layer and the overlaminate layer is within a range of from 0% to 15% and particularly from 1% to 10%. And the differential for transverse direction (TD) shrinkage of the foam layer and the overlaminate layer is within a range of from 0% to 40%, and particularly from 0% to 30%.

It will be appreciated that the present subject matter is not limited to, or based upon, any particular phenomena concerning the relationship between the shrinkable foam layer, and the shrinkable overlaminate layer. That is, although the subject matter can be conveniently characterized as selectively and/or designing these components relative to one another such that their shrinkage extents are matched, the subject matter also includes systems in which the shrink forces are balanced with the bonding forces. For example, it is contemplated that the subject matter includes a system of a shrinkable overlaminate layer and a shrinkable foam layer having characteristics such that upon bonding the foam layer to the overlaminate layer and shrinking both components, no wrinkles, peel-up, or distortion are exhibited in the label or regions of the outer overlaminate layer because the shrink forces associated with those components are balanced with the bonding forces between those components.

The multilayer heat shrinkable label assembly of the present subject matter exhibits particular thermal insulating characteristics. In one aspect of the present subject matter, the label assemblies exhibit “a 5 degree F. differential versus an aluminum can over 30 minutes at room temperature.” This refers to two cans, one can being an uninsulated aluminum can and another aluminum can having the insulated label around its outer surface, both at a chilled temperature (such as for example at a temperature of about 40° F., such as in a refrigerator). The two cans are then exposed to room temperature, e.g., about 68° F., at the same time. After 30 minutes of exposure to room temperature, the can with the insulated label will be at a temperature of at least 5 degrees F. lower than the temperature of the uninsulated aluminum can.

The label assemblies of the present subject matter can include additional layers and/or components. For example, one or more agents can be included in the overlaminate layer and/or the foam layer to modify opacity or color. UV blockers or other additives could also be incorporated into one or more layers of the label assemblies. The label assemblies also include additional layers such as additional foam layers to impart increased insulating properties and “cushion” to the resulting label assembly. It is also contemplated that an outer layer of a rubberized ink or other material may be used to impart grip enhancing properties. Other functionalized layers are also envisioned. A wide array of other features or characteristics can be incorporated in the present subject matter labels such as, but not limited to, thermochromic inks, embossing, and cold stamped foils.

### Labeling System

The present subject matter also provides a labeling system that comprises the previously noted shrinkable foam layer, the shrinkable overlaminate layer separate from the foam layer, and optionally in further combination with the previously noted adhesive layer. These separate components can be supplied in conjunction with one another to an end-user such as a beverage producer, packaging entity, or other end user. The label system will find wide application in a variety of industries.

### Methods

The present subject matter provides a wide range of methods and processes for labeling goods by use of the systems described herein.

In addition, it is also contemplated that a method of labeling an item or other good(s) can utilize a series of operations in which a heat shrinkable label or label assembly is provided in sheet or web form. Next, one or more item(s) to be labeled are then enclosed using the heat shrinkable material. This can be achieved in several fashions such as by wrapping the item in the heat shrinkable material. Another approach is to form a flexible wall container such as in the form of a tube or sleeve, from the heat shrinkable label assembly and then placing the item(s) within the flexible wall container. After appropriately enclosing the item(s) with the heat shrinkable label assembly, the heat shrinkable label is subjected to one or more operations to affect shrinkage about the item(s).

In a particular method of the present subject matter, a multilayer label assembly as described herein is provided such as from a reel or a roll of such stock. The label is positioned relative to a can or other container to be labeled, so that the overlaminate layer is directed away from the can. The rear face of the label is contacted with the can and the label is wrapped around the can. An effective amount of adhesive such as a hot melt adhesive can be applied to a leading edge of the label to secure or otherwise attach the label to the can. The can (or other container) is rotated and the label completes a full wrap around the can. An effective amount of adhesive such as for example a hot melt or a solvent seaming adhesive as known in the art is applied to the trailing edge of the label. A wide array of hot melt adhesives are commercially available such as those from Henkel Adhesives and H. B. Fuller. Seaming solvent adhesives are commercially available from Flexcraft Industries for example. The adhesives disposed between the inner face of the label and the can or container serve to at least initially adhere or secure the label to the can, and particularly prior to heat shrinking of the label.

Furthermore, it is also contemplated that other strategies could be performed to induce shrinkage, besides heating. For example, it is also contemplated that other techniques may be utilized to induce shrinkage of the flexible wall container and/or the label assembly. For example, exposure to electromagnetic radiation and in particular infra-red radiation or microwave radiation could be utilized to induce shrinkage.

The present subject matter also provides methods of producing a labeling system. These methods involve providing a heat shrinkable foam layer and a heat shrinkable overlaminate layer. The layers are selected such that their heat shrink characteristics match one another as described herein. The foam layer and the overlaminate layer are then secured or adhered to one another by use of an effective amount of adhesive between the layers.

### Additional Aspects

If the inner and/or outer face of the overlaminate layer does not have a surface suitable for printing, the labeling material of the present subject matter can further include a coating on the face material. This coating is typically printable. The coating can be a standard print primer based on aqueous polymer dispersions, emulsions or solutions of acrylic, urethane, polyester or other resins well known in the art. Alternatively, if the thermal insulating layer is previously printed, and the face material is clear, the need for coating the face material to make it printable may be eliminated.

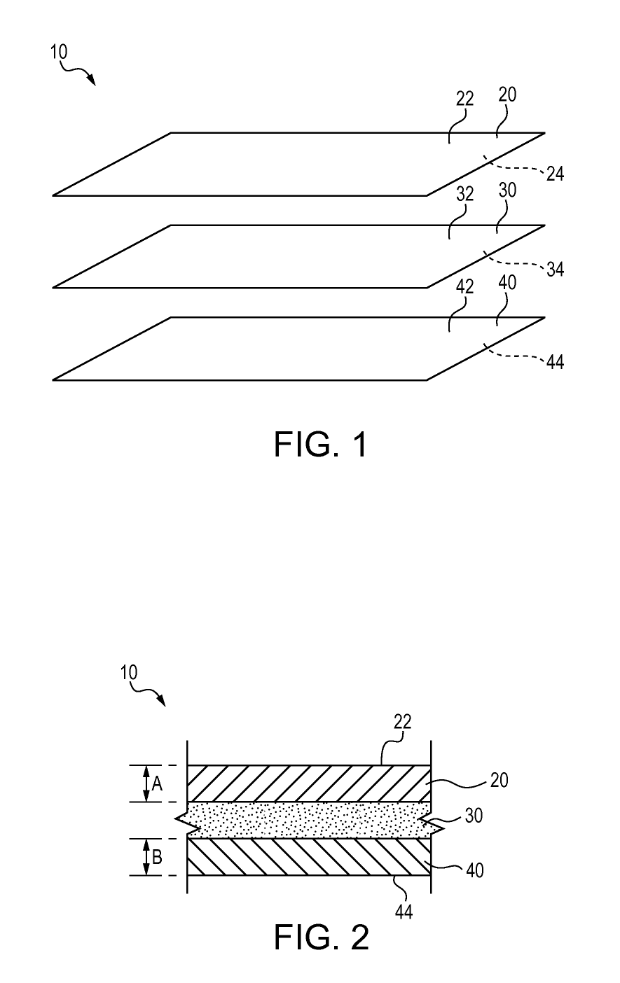

FIG. 1 is an exploded schematic view of a multilayer heat shrinkable label assembly 10 in accordance with the present subject matter. The label assembly 10 comprises an overlaminate layer 20, an adhesive layer 30, and a foam insulating layer 40. The overlaminate layer 20 defines an outer face 22 and an oppositely directed inner face 24. Various print, designs, and/or other indicia can be applied onto the inner face 24 to reverse print a clear or transparent overlaminate layer. The foam layer 40 defines a first face 42 and an oppositely directed second face 44. Upon application of the label 10 to a can or other container of interest, the second face 44 is directed to the can and typically contacts an outer surface of the can. The adhesive layer 30 may also define oppositely directed first and second faces 32, 34.

FIG. 2 illustrates a schematic cross-sectional view of the label assembly 10. In this particular version, the thickness of the overlaminate layer 20 is in a range of from 0.48 mils to 4 mils, i.e., span A in FIG. 2; and the thickness of the foam layer 40 is in a range of from 1 mil to 14 mils, i.e., span B. The overall thickness of the label assembly 10 is from 2 mils to 15 mils.

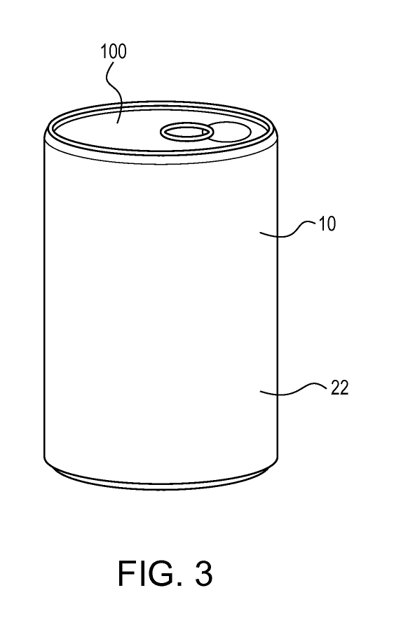

FIG. 3 illustrates a typical beverage container 100 having a label 10 secured along at least a portion of its outer surface. The outer face 22 of the overlaminate layer is directed outward from the container 100.

Many other benefits will no doubt become apparent from future application and development of this technology.

All patents, published applications, and articles noted herein are hereby incorporated by reference in their entirety.

As described hereinabove, the present subject matter solves many problems associated with previous strategies, systems and/or articles. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A multilayer heat shrinkable label assembly comprising:
an overlaminate layer;
a foam layer adhered to the overlaminate layer, the foam layer including a material selected from the group consisting of polystyrene, polyethylene, polyurethane, polyvinyl chloride, polyolefin(s), and combinations thereof, the foam layer including at least 50% closed cells.

2. The label assembly of claim 1, wherein the foam layer includes polystyrene.

3. The label assembly of claim 1, wherein the foam layer includes at least 75% closed cells.

4. The label assembly of claim 3, wherein the foam layer includes at least 90% closed cells.

5. The label assembly of claim 1, wherein the foam layer has a density in a range of from 0.15 g/cm³ to 0.50 g/cm³.

6. The label assembly of claim 5, wherein the foam layer has a density in a range of from 0.25 g/cm³ to 0.35 g/cm³.

7. The label assembly of claim 1, wherein the foam layer has a thickness of from 0.8 mils to 20 mils.

8. The label assembly of claim 7, wherein the foam layer has a thickness of from 1 mil to 14 mils.

9. The label assembly of claim 1, wherein the overlaminate layer includes a material selected from the group consisting of polystyrene, polyethylene terephthalate (PET), biaxially oriented polypropylene (BOPP), polyvinyl chloride, polyethylene terephthalate glycol-modified (PETG), polyolefins, polyolefin blends, and combinations thereof.

10. The label assembly of claim 1, wherein the overlaminate layer has a thickness in a range of from 0.40 mils to 5 mils.

11. The label assembly of claim 10, wherein the overlaminate layer has a thickness in a range of from 0.48 mils to 4 mils.

12. The label assembly of claim 1, wherein the overlaminate layer exhibits a clarity greater than 90%.

13. The label assembly of claim 12, wherein the overlaminate layer exhibits a clarity greater than 95%.

14. The label assembly of claim 1, wherein the overlaminate layer exhibits a haze of less than 10%.

15. The label assembly of claim 14, wherein the overlaminate layer exhibits a haze of less than 5%.

16. The label assembly of claim 1, wherein the overlaminate layer exhibits a 60 degree gloss greater than 100.

17. The label assembly of claim 16, wherein the overlaminate layer exhibits a 60 degree gloss greater than 120.

18. The label assembly of claim 1, wherein the label assembly exhibits a thermal insulating property of 5 degrees F. differential versus an aluminum can over 30 minutes at room temperature.

19. The label assembly of claim 1, wherein the extent of machine direction (MD) heat shrink of the overlaminate layer compared to the foam layer is within a range from 0% to 15%.

20. The label assembly of claim 19, wherein the extent of machine direction (MD) heat shrink of the overlaminate layer compared to the foam layer is within a range from 1% to 10%.

21. The label assembly of claim 1, wherein the extent of transverse direction (TD) heat shrink of the overlaminate layer compared to the foam layer is within a range from 0% to 40%.

22. The label assembly of claim 21, wherein the extent of transverse direction (TD) heat shrink of the overlaminate layer compared to the foam layer is within a range from 0% to 30%.

23. The label assembly of claim 1, wherein the label assembly has a thickness in a range of from 1.5 mils to 20 mils.

24. The label assembly of claim 23, wherein the label assembly has a thickness in a range of from 2 mils to 15 mils.

25. A multilayer heat shrinkable label assembly comprising:
a foam layer;
an overlaminate layer, the overlaminate layer including a material selected from the group consisting of polystyrene, polyethylene terephthalate (PET), biaxially oriented polypropylene (BOPP), polyvinyl chloride, polyethylene terephthalate glycol-modified (PETG), polyolefins, polyolefin blends, and combinations thereof; and
an adhesive layer disposed between the foam layer and the overlaminate layer.

26. The label assembly of claim 25, wherein the overlaminate layer exhibits a haze of less than 10%.

27. The label assembly of claim 26, wherein the overlaminate layer exhibits a haze of less than 5%.

28. The label assembly of claim 25, wherein the overlaminate layer exhibits a 60 degree gloss greater than 100.

29. The label assembly of claim 28, wherein the overlaminate layer exhibits a 60 degree gloss greater than 120.

30. The label assembly of claim 25, wherein the overlaminate layer has a thickness in a range of from 0.40 mils to 5 mils.

31. The label assembly of claim 30, wherein the overlaminate layer has a thickness in a range of from 0.48 mils to 4 mils.

32. The label assembly of claim 25, wherein the overlaminate layer exhibits a clarity greater than 90%.

33. The label assembly of claim 32, wherein the overlaminate layer exhibits a clarity greater than 95%.

34. The label assembly of claim 25, wherein the foam layer includes a material selected from the group consisting of polystyrene, polyethylene, polyurethane, polyvinyl chloride, polyolefins, and combinations thereof.

35. The label assembly of claim 34, wherein the foam layer includes polystyrene.

36. The label assembly of claim 25, wherein the foam layer includes at least 50% closed cells.

37. The label assembly of claim 36, wherein the foam layer includes at least 75% closed cells.

38. The label assembly of claim 37, wherein the foam layer includes at least 90% closed cells.

39. The label assembly of claim 25, wherein the foam layer has a density in a range of from 0.15 g/cm³ to 0.50 g/cm³.

40. The label assembly of claim 39, wherein the foam layer has a density in a range of from 0.25 g/cm³ to 0.35 g/cm³.

41. The label assembly of claim 25, wherein the foam layer has a thickness of from 0.8 mils to 20 mils.

42. The label assembly of claim 41, wherein the foam layer has a thickness of from 1 mil to 14 mils.

43. The label assembly of claim 25, wherein the label assembly exhibits a thermal insulating property of 5 degrees F. differential versus an aluminum can over 30 minutes at room temperature.

44. The label assembly of claim 25, wherein the extent of transverse direction (TD) heat shrink of the overlaminate layer compared to the foam layer is within a range from 0% to 40%.

45. The label assembly of claim 44, wherein the extent of transverse direction (TD) heat shrink of the overlaminate layer compared to the foam layer is within a range from 0% to 30%.

46. The label assembly of claim 25, wherein the extent of machine direction (MD) heat shrink of the overlaminate layer compared to the foam layer is within a range from 0% to 15%.

47. The label assembly of claim 46, wherein the extent of machine direction (MD) heat shrink of the overlaminate layer compared to the foam layer is within a range from 1% to 10%.

48. The label assembly of claim 25, wherein the label assembly has a thickness in a range of from 1.5 mils to 20 mils.

49. The label assembly of claim 48, wherein the label assembly has a thickness in a range of from 2 mils to 15 mils.

50. A method of labeling a container, the method comprising:
providing a multilayer heat shrinkable label assembly including (i) an overlaminate layer, and (ii) a foam layer, the foam layer defining an inner face;
contacting the inner face of the multilayer heat shrinkable label assembly to a container;
heating the multilayer heat shrinkable label assembly about at least a portion of the container, whereby both the overlaminate layer and the foam layer undergo shrinkage, to thereby label the container.

51. The method of claim 50, further comprising:
applying an effective amount of adhesive between at least a portion of the inner face of the label and the container.

52. The method of claim 51, whereby upon performing at least one of the contacting or heating, the label is adhered to the container.
